(19) United States
(12) Patent Application Publication
(10) Pub. No.: US 2006/0047821 A1
(43) Pub. Date: Mar. 2, 2006

(54) System, method, and medium for relaying data using socket application program

(75) Inventor: Jae-hwan Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/130,235

(22) Filed: May 17, 2005

(30) Foreign Application Priority Data
May 28, 2004 (KR) 2004-38351

(51) Int. Cl. G06F 15/16

(52) U.S. Cl. 709/227

(57) ABSTRACT

Provided are a method and system for relaying data using a socket application program. The data relay system includes a server socket module that receives data requesting access to a server from the first and second clients and establishes a connection between the server and either the first or second client at an application layer using predetermined connection information, a connection information storage module into which the connection information associated with the first and second clients are mapped for storage, and a data relay module that relays the data transmitted from the first and second clients at a network layer using the mapped connection information.

### CROSS-REFERENCE TO RELATED APPLICATIONS

This application claims the benefit of Korean Patent Application No. 10-2004-0038351 filed on May 28, 2004 in the Korean Intellectual Property Office, the disclosure of which is incorporated herein by reference in its entirety.

### BACKGROUND OF THE INVENTION

1. Field of the Invention

The present invention relates to data relay, and more particularly, to a system and method for more quickly relaying data using a socket application program, wherein an application layer is responsible for making a connection and a disconnection for data transmission, and wherein a network layer is responsible for relaying data.

2. Description of the Related Art

Advancement in networking and communication technology leads to development of various application programs using sockets (hereinafter called a ‘socket applications’). Sockets are a method for communication between a client program and a server program running on the network. Sockets are created and used with a set of programming requests or function calls commonly called the sockets application programming interface (API). The most common sockets API is the Berkeley UNIX C language interface. Sockets can also be used for communication between processes within the same computer.

Thus, socket applications can perform various tasks related to a network, one of which is to relay data between computers in different networks, such as instant messaging services.

FIG. 1 is an exemplary diagram of a conventional instant messaging system.

Referring to FIG. 1, a conventional system 100 for providing an instant messaging service includes a server 120 that provides instant messaging services, and a plurality of clients 140 and 160, which are connected to the server 120 and are provided with the instant messaging services. For a better understanding of the invention, it is assumed that there are two clients on different networks, which are called client-A 140 and client-B 160, respectively. Here, the client-A 140 and the client-B 160 belong to first and second networks 130 and 150, respectively. The server 120 resides on the Internet 110 to which the first and second networks 130 and 150 are connected.

In general, the first and second networks 130 and 150 each include a firewall with unique policy that protects the network resources. Thus, to provide the instant messaging service by solving the firewall problems, socket applications can be used. The socket applications are classified as a ‘server socket application’ running on the server 120 and ‘client socket applications’ running on the client-A 140 and the client-B 160.

The client-A 140 and the client-B 160 cannot exchange text, images, and voice data directly with each other using instant messaging service due to firewalls installed on the first and second networks 130 and 150 or network address translation (NAT) or port address translation (PAT). While the client-A 140 and the client-B 160 use the appropriate client socket applications to connect to the server 120 residing on the Internet 100, the server 120 uses the server socket application to relay data between the client-A 140 and the client-B 160.

FIG. 2 is an exemplary diagram showing network connection between the server 120 and the clients 140 and 160, and showing data exchange between the clients 140 and 160 in the system 100 of FIG. 1 based on an open systems interconnection (OSI) seven-layer architecture 200. The OSI seven-layer architecture 200 represents a protocol stack when the server 120 provides an instant messaging service using the server socket application.

The client-A 140 accesses the server socket application installed on the server 120 using its own client socket application (step 210). The client-B 160 also accesses the server socket application using its own client socket application (step 220). Then, the server socket application relays data between the client-A 140 and the client-B 160 at an application layer (step 230).

By providing instant messaging service in this way, it is possible to solve problems associated with firewalls that have different policies for different networks. That is, the client socket application, which makes a request for access via a service port registered with a firewall, sends data for transmission outside the firewall together with information on its own source port. When the source port is registered with the firewall, data can be exchanged freely for a predetermined period of time.

However, since data relay in the server 120 occurs at the application layer, the speed of data relay and quality of instant messaging service tend to decrease.

In other words, the speed of data relay decreases due to propagation delay between the lower three layers (physical layer, data link layer, and network layer) and buffering delays. The buffering delays are caused by fragmentation and defragmentation between the transport layer and the application layer or a transport layer congestion control. The buffering delays can occur within the socket at the application layer.

Thus, in order to provide services through socket applications, there is a need for a mechanism for performing data relay in a faster manner.

### SUMMARY OF THE INVENTION

The present invention provides a method and system for more quickly relaying data under reduced server load and providing stable service to users by performing data relay at a network layer instead of at an application layer.

Additional aspects, features and/or advantages of the present invention will be set forth in part in the description which follows and, in part, will be apparent from the description, or may be learned by practice of the invention.

According to an aspect of the present invention, there is provided a system for relaying data using a socket application program including a server socket module that receives data requesting access to a server from the first and second clients and establishes a connection between the server and the first client and between the server and the second client at an application layer using predetermined connection information, a connection information storage module into which the connection information associated with the first and second clients are mapped for storage, and a data relay module that relays the data transmitted from the first and second clients at a network layer using the mapped connection information.

According to another aspect of the present invention, there is provided a method for relaying data using a socket application program, including the first and second clients making an access request to an application layer on a server, the server establishing a connection with the first and second clients at the application layer using predetermined mapped connection information, and the server relaying data received from the first and second clients at a network layer using the mapped connection information.

At least one computer readable medium storing instructions that control at least one processor to perform a method for relaying data using a socket application program including making an access request to an application layer on a server by a first and a second client; establishing a connection with the first and the second client at the application layer using predetermined mapped connection information by the server; and allowing the server to relay data received from the first and the second client at a network layer using the mapped connection information.

According to another aspect of the present invention, there is provided a method for relaying data using a socket application program, including establishing a connection between a first client and a second client through a server; and allowing the server to relay data received from the first and the second clients at a network layer using mapped connection information.

According to another aspect of the present invention, there is provided at least one computer readable medium storing instructions that control at least one processor to perform a method for relaying data using a socket application program including establishing a connection between a first client and a second client through a server; and allowing the server to relay data received from the first and the second clients at a network layer using mapped connection information.

### BRIEF DESCRIPTION OF THE DRAWINGS

The above and other aspects, features and advantages of the present invention will become more apparent by describing in detail exemplary embodiments thereof with reference to the attached drawings in which:

FIG. 1 is an exemplary diagram of a conventional instant messaging system;

FIG. 2 is an exemplary diagram showing network connection between the server and the clients and data exchange between the clients in the system of FIG. 1;

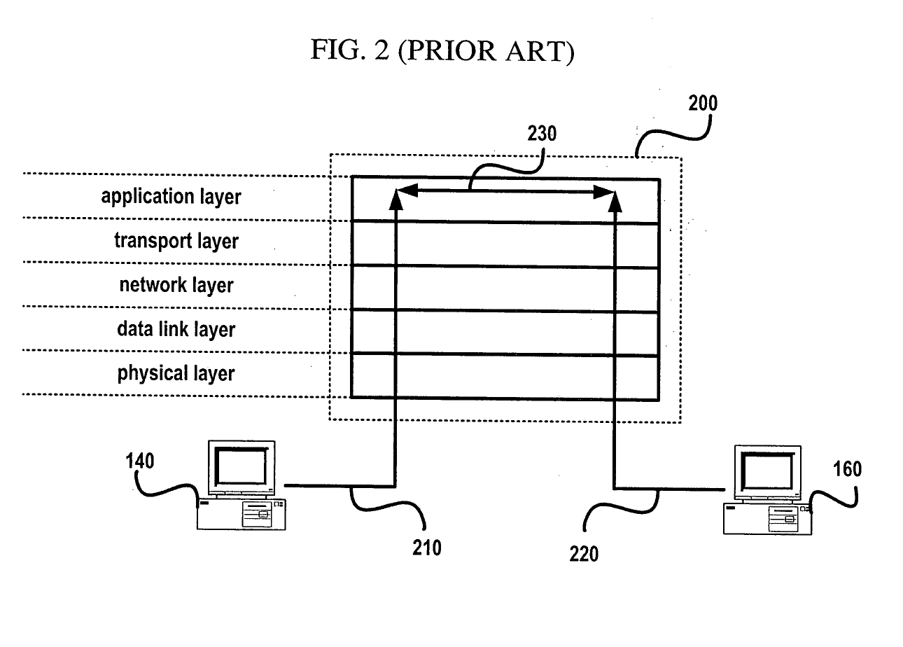

FIG. 3 is an exemplary diagram showing network connection between server and clients and data exchange between the clients, according to an exemplary embodiment of the present invention;

FIG. 4 is a diagram of an instant messaging system, according to an exemplary embodiment of the present invention;

FIG. 5 is a flowchart illustrating the operation of a server socket module, according to an exemplary embodiment of the present invention;

FIG. 6 is a flowchart illustrating the operation of a data relay module, according to an exemplary embodiment of the present invention; and

FIG. 7 is a flowchart illustrating the operation of a client socket application module, according to an exemplary embodiment of the present invention.

### DETAILED DESCRIPTION OF THE PREFERRED EMBODIMENTS

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures. The present invention may, however, be embodied in many different forms and should not be construed as being limited to the exemplary embodiments set forth herein. Rather, these exemplary embodiments are provided so that this disclosure will convey the concept of the invention to those skilled in the art.

The present invention is described hereinafter with reference to block or flowchart illustrations of data relaying methods, according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, can be executed to implement the functions specified in the flowchart block or blocks. The programmable data processing apparatus can also be any type of wired or wireless computing device. The computer program instructions can be executed by one or more processors of one or more general purposed computers, special purpose computers, or other programmable data processing apparatuses.

These computer program instructions may also be stored in a computer usable or computer-readable memory that can direct a computer or other programmable data processing apparatus to function in a particular manner, such that the instructions stored in the computer usable or computer-readable memory produce an article of manufacture, which implements the functions specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks. The memory may be distributed among computers or computing devices as part of one or more networks or coupled with one or more networks. The networks may be wireless networks, wired networks, the Internet, or a combination thereof.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

These computer program instructions, modules, segments, or portions of code may be stored in a computer-readable data storage medium so that the computer program instructions can be read and executed by any computer or computing device. Examples of computer-readable data storage medium include a magnetic recording medium (e.g., a ROM, a floppy disk, a hard disk, etc.), an optical recording medium (e.g., a CD-ROM, DVD, etc.), and a carrier wave medium or digital transmission medium (e.g., data transmission through the Internet, wired networks, wireless networks, or any combination thereof). Examples of the computer-readable data storage medium further include any type of transmission medium including networks, which may be wired networks, wireless networks, or any combination thereof. The computer-readable data storage medium may also be referred to as a computer-readable medium, medium, or memory. The computer-readable data storage medium may be distributed among computers or computing devices as part of one or more networks or coupled with one or more networks, wherein the networks may be wired networks, wireless networks, the Internet, or any combination thereof.

To aid in the understanding of the present invention, exemplary embodiments of the present invention will now be described in detail with reference to an instant messaging service using a socket application.

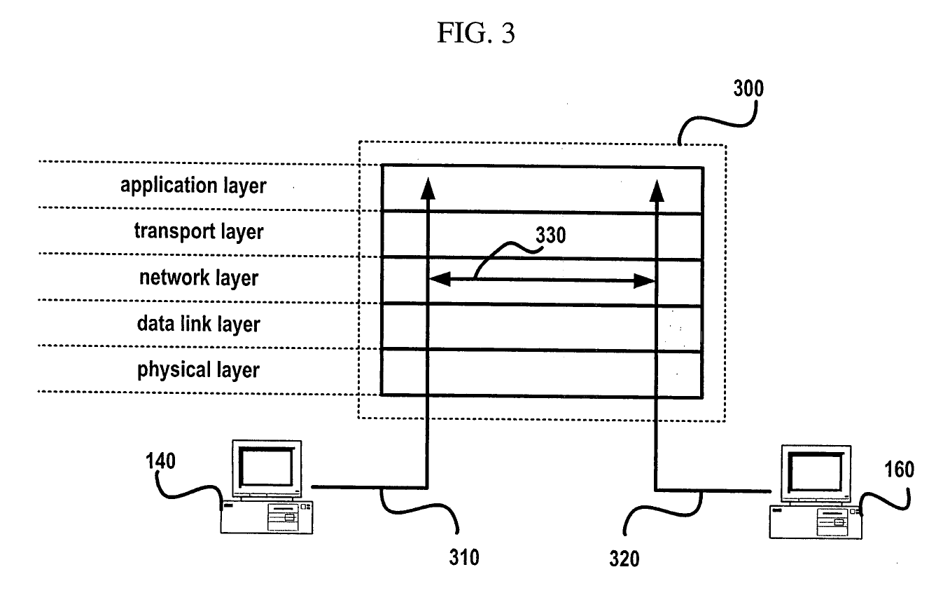

FIG. 3 shows a network connection between a server and a plurality of clients and data exchange between the clients based on an open systems interconnection (OSI) seven-layer architecture 300. The OSI seven-layer architecture 300 represents a protocol stack when the server provides an instant messaging service using a server socket application. For a better understanding of the invention, exemplary embodiments of the present invention will now be described with reference to the network system 100 for performing an instant messaging service.

The client-A 140 accesses the server socket application installed on the server 120 using its own client socket application (step 310). The client-B 160 also accesses the server socket application using its own client socket application (step 320). Then, the server socket application relays data between the client-A 140 and the client-B 160 at a network layer (step 330). That is, the application layer handles the connection between the server 120 and either the client-A 140 or client-B 160 while the network layer handles data relay between the client-A 140 and client-B 160.

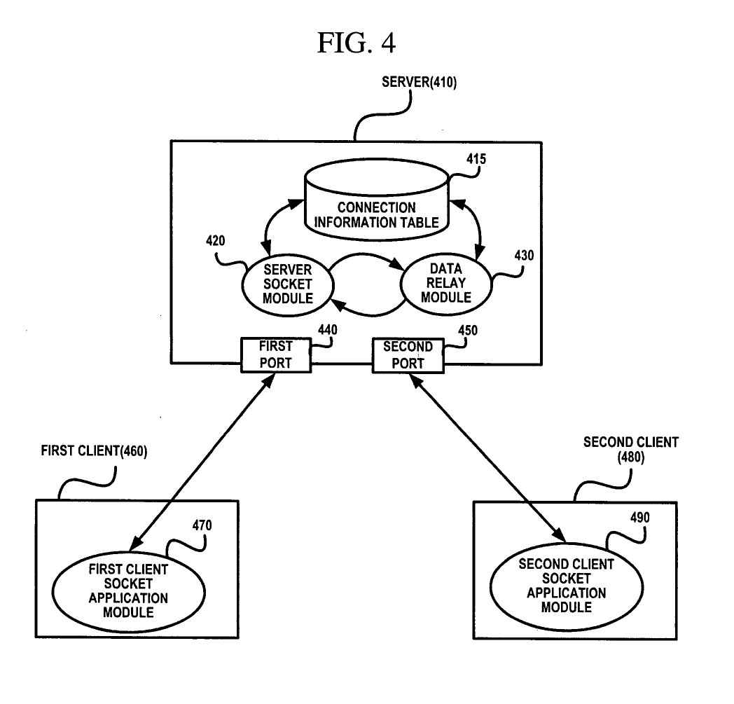

FIG. 4 is a diagram of an instant messaging system, according to an exemplary embodiment of the present invention.

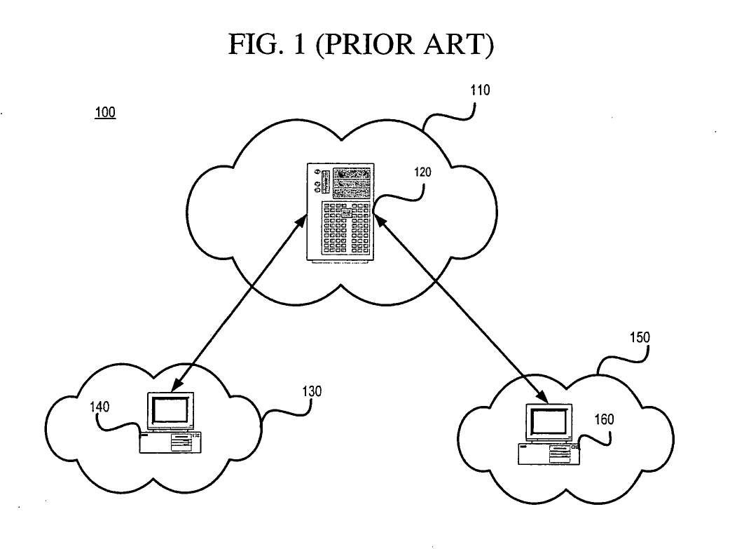

While the system architecture of FIG. 4 is similar to that of FIG. 1, a server socket module 420, a data relay module 430, and a connection information table 415 are mounted in a server 410 and act as a server socket application. The server socket module 420 establishes a connection between first and second clients 460 and 480 and the server 410, or terminates the connection when data relay terminates. Once the connection has been established between the server 410 and the clients 460 and 480, the data relay module 430 relays data received from the first and second clients 460 and 480 at a network layer. The connection information table 415 is a data structure that stores information needed to connect the first and second clients 460 and 480 to the server 410 such as information on IP addresses and ports.

The term ‘module’, as used herein, generally refers to, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The operation between each module will now be described. When the first and second clients 460 and 480 desire to use an instant messaging service, first and second client application modules 470 and 490 attempt to access the server 410. In this case, the first and second client application modules 470 and 490 can connect to the server 410 via first and second ports 440 and 450 mounted in the server 410, respectively. The first and second ports 440 and 450, either physical or logical, can be predefined or determined by an operating system installed on the server 410 when the client 460 or 480 makes a request for access to the server 410.

When the first and second clients 460 and 480 attempt to access the server 410, the server socket module 420 establishes a connection between the first and second clients 460 and 480 and the server 410 at an application layer in a protocol stack where the server socket application operates. In this case, the server socket module 420 manages information needed to connect the first and second client socket application modules 470 and 490 in the connection information table 415. The connection information contains information on IP addresses and ports.

Once a connection has been established between the server 410 and the first and second clients 460 and 480, the data relay module 430 relays data transmitted from the first and second clients 460 and 480 at a network layer in a protocol stack where the server socket application operates, referring to information about the appropriate IP addresses and port numbers contained in the connection information table 415. Upon termination of data relay between the first and second clients 460 and 480, the server socket module 420 deletes the appropriate connection information from the connection information table 415 and then terminates the connection between the server 410 and the clients 460 and 480.

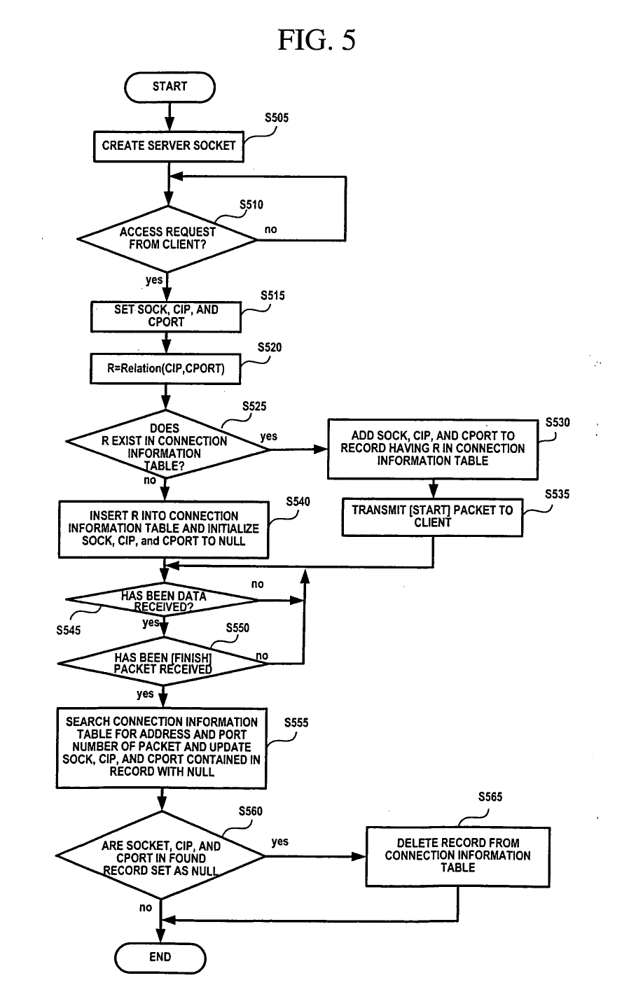

FIG. 5 is a flowchart illustrating the operation of a server socket module, according to an exemplary embodiment of the present invention.

Referring to FIG. 5, the server socket module 420 running on the server 410 as a daemon creates a socket in step 505, and waits for access requests to come in from the first and second clients 460 and 480 in step S510. To aid in the understanding of the present invention, it is assumed that the first and second clients 460 and 480 shown in FIG. 4 use an instant messaging service. When the first client 460 makes a request for access to the server 410, IP address CIP and port number CPORT of the first client 460 and socket SOCK that is created by the server 410 and receives the access request are set in step S515. In step S520, a relation operation is performed using the IP address CIP and the port number CPORT of the first client 460 as parameters to obtain a relation variable R.

The server socket module 420 checks whether the relation variable R exists in the connection information table 415.

In this case, the connection information table 415 contains address mapping information needed to relay data between the clients 460 and 480, such as a plurality of records, each record including fields of R, first client information, and second client information. Here, the first and second clients 460 and 480 means ones that transmit and receive data between each other, and the relation variable R has the same value for the first and second clients 460 and 480. The first client information contains SOCK_1, CIP_1, and CPORT_1 while the second client information contains SOCK_2, CIP_2, and CPORT_2. SOCK_1 and SOCK_2 respectively denote sockets that are created by the server 410 and receive access requests made by the first and second clients 460 and 480. CIP_1 and CIP_2 respectively denote IP addresses of the first and second clients 460 and 480. CPORT_1 and CPORT_2 respectively denote port numbers of the first and second clients 460 and 480. The connection information table 415 is updated using a technique such as Semaphore or Mutex (mutual exclusion object).

In step S530, if the same value as the relation variable R exists in the connection information table 415, which means that the second client 480 has already connected to the server 410 for data exchange with the first client 460 that has made a request for access to the server 410, the first client information SOCK_1, CIP_1, CPORT_1 is added to a first client information field, which had previously been set as NULL, in a record having the same relation variable R. Then, in step S535, a [START] packet requesting data transmission is transmitted to the first and second clients 460 and 480.

Conversely, in step S540, unless the same value as the relation variable R exists in the connection information table 415, which means that no connection is established between the server 410 and the second client 480, the relation variable R and SOCK_1, CIP_1, and CPORT_1 of the first client 460 that has made a request for access to the server 410 are inserted into the connection information table 415 while the second client information field associated with the second client 480 that does not connect to the server 410 yet is set as NULL. In this case, when a field set as NULL is updated with the second client information containing SOCK_2, CIP_2, and CPORT_2 by an access request from the second client 480, a [START] packet requesting data transmission is transmitted to the first and second clients 460 and 480. Thereby, the server 410 finishes preparation for relaying data between the first and second clients 460 and 480.

The server 410 may utilize the data relay module 430 in order to perform data relay.

When the server 410 receives all data from the first client 460 and then a [FINISH] packet indicating that all data have been received from the first client 460 in steps S545 and S550, the connection information table 415 is searched for an address and a port number of the packet to find a record containing the address and the port number of the packet and then SOCK_1, CIP_1, and CPORT_1 contained in the record is updated with NULL in step S555. Then, in step S560, it is checked whether the second client information field is set as NULL. When the second client information field is all set as NULL, the appropriate record is deleted from the connection information table 415 in step S565. Conversely, when the second client information field is not set as NULL, the server socket module 420 closes the sockets through which the server 410 has connected to the first and second clients 460 and 480.

Meanwhile, the processes from the steps S510 to S560 or from steps S510 to S565 may be performed in separate threads created by the server socket module 420.

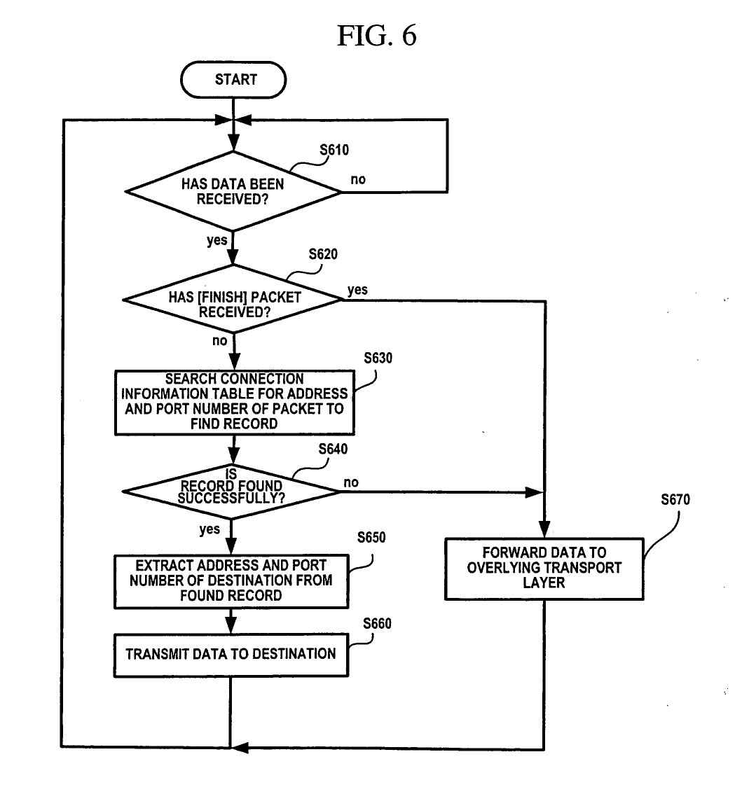

FIG. 6 is a flowchart illustrating the operation of a data relay module, according to an exemplary embodiment of the present invention.

The data relay module 430 can run as a daemon program like the server socket module 420. The data relay module 430 interacts with the server socket module 420 to relay data between the first and second clients 460 and 480 at a network layer.

That is, when a connection is made between the first and second clients 460 and 480 and the server 410 at the application layer, IP addresses and port numbers for the first and second clients 460 and 480 are mapped into the connection information table 415 for storage.

Thus, for example, when data is received from the first client 460 in step S610 and the received data is not a [FINISH] packet indicating that data transmission from the first client 460 is completed in step S620, the connection information table 415 is searched for an address and a port number of the data packet to find a record in step S630.

When the address and the port number of the data packet are found successfully in step S640, an address and a port number of the packet's destination are extracted from the found record in step S650, and the data packet is forwarded to the destination in step S660.

Conversely, when the received data is a [FINISH] packet in step S620 or when the address and the port number of the data packet are not found successfully in step S640, the data relay module 430 transmits the received data to an overlying transport layer instead of a network layer in step S670.

When a user interface for an instant messaging service running on the first or second client 460 or 480 terminates while the data relay module 430 operates, the operation of the data relay module 430 illustrated in FIG. 6 also terminates.

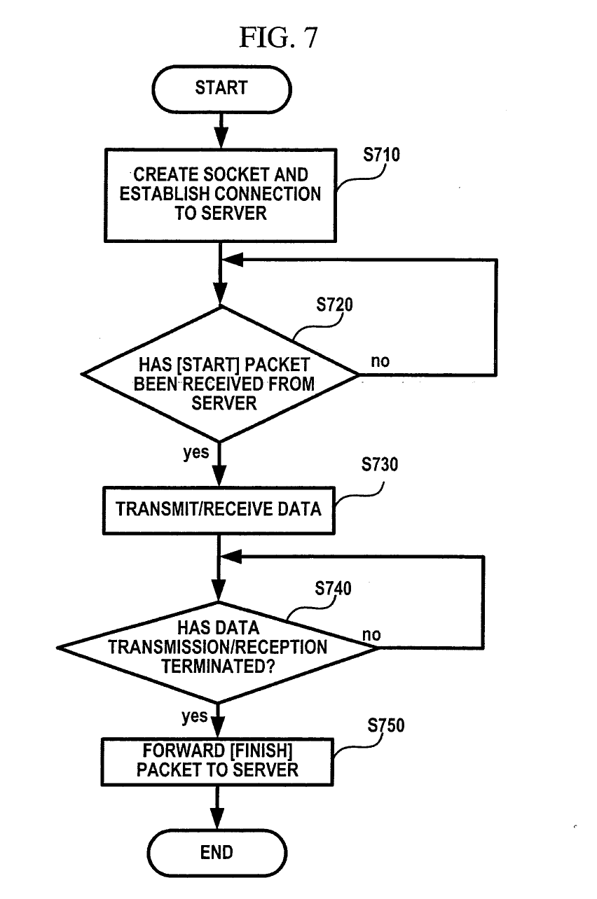

FIG. 7 is a flowchart illustrating the operation of a client socket application module, according to an exemplary embodiment of the present invention. While the operation will be described with reference to the first client socket application module 470, the same applies to the second client socket application module 490.

In order to transmit/receive data to/from the second client 480 using the instant messaging service, the first client 460 first needs to connect to the server 410. Thus, in step S710, the first client socket application module 470 creates a socket and establishes a connection to the server 410.

Once the server 410 has established a connection with the first and second clients 460 and 480 at the application layer, [START] packets requesting the start of data transmission are transmitted to the clients 460 and 480, respectively. Thus, in step S720, the first client socket application module 470 checks whether the [START] packet has been received from the server 410. If the first client socket module 470 has received the [START] packet from the server 410, the first client 460 starts to transmit data to the server 410. In step S730, the first client 460 receives data that has been transmitted from the second client 480 from the server 410. When data transmission/reception terminates in step S740, the first client socket application module 470 forwards a [FINISH] packet indicating that data transmission terminates to the server 410, closes the socket, and terminates the instant messaging service in step S750.

In concluding the detailed description, a server, designed to provide various services using a socket application according to exemplary embodiments of the present invention, relays data at a network layer using socket information of a client, thereby reducing delay in data relay that tends to occur in a socket application.

Although a few exemplary embodiments of the present invention have been shown and described, it would be appreciated by those skilled in the art that changes may be made in these embodiments without departing from the principles and spirit of the invention, the scope of which is defined in the claims and their equivalents. Therefore, the disclosed exemplary embodiments of the invention are used in a generic and descriptive sense only and not for purposes of limitation.

What is claimed is:

1. A system for relaying data using a socket application program, the system comprising:
a server socket module that receives data requesting access to a server from the first and second clients and establishes a connection between the server and the first client and between the server and the second client at an application layer using predetermined connection information;
a connection information storage module into which the connection information associated with the first and second clients are mapped for storage; and
a data relay module that relays the data transmitted from the first and second clients at a network layer using the mapped connection information.

2. The system of claim 1, wherein the connection information comprises IP addresses and port numbers of the first and second clients and sockets that receive the data requesting an access from the first and second clients.

3. The system of claim 1, wherein the server socket module forwards information indicating the start of data transmission to the first and second clients upon establishment of the connection between the server and the first and second clients.

4. The system of claim 1, wherein the server socket module closes sockets that receive the data requesting an access from the first and second clients when relay of the data received from the first and second clients terminates.

5. The system of claim 1, wherein the connection information associated with the first and second clients are mapped into the connection information storage module for storage using a value obtained as a result of a relation operation as a key value, wherein the relation operation is performed using the IP address and port number of either the first or second client.

6. A method for relaying data using a socket application program, the method comprising:
making an access request to an application layer on a server by a first client and a second client;
establishing a connection with the first and the second clients at the application layer using predetermined mapped connection information by the server; and
allowing the server to relay data received from the first and the second clients at a network layer using the mapped connection information.

7. The method of claim 6, wherein the connection information comprises IP addresses and port numbers of the first and second clients and sockets that receive data requesting an access from the first and second clients.

8. The method of claim 6, wherein the establishing of the connection comprises forwarding information indicating the start of data transmission to the first and second clients.

9. The method of claim 6, wherein the allowing the server to relay data comprises closing sockets that receive data requesting an access from the first and second clients when relay of the data received from the first and second clients terminates.

10. The method of claim 6, wherein the mapped connection information comprises connection information mapped using a value obtained as a result of a relation operation as a key value, wherein the relation operation is performed using the IP address and port number of either the first or second client.

11. At least one computer readable medium storing instructions that control at least one processor to perform a method for relaying data using a socket application program comprising:
making an access request to an application layer on a server by a first and a second client;
establishing a connection with the first and the second client at the application layer using predetermined mapped connection information by the server; and
allowing the server to relay data received from the first and the second client at a network layer using the mapped connection information.

12. The at least one computer readable medium of claim 11, wherein the connection information comprises IP addresses and port numbers of the first and second clients and sockets that receive the data requesting an access from the first and second clients.

13. The at least one computer readable medium of claim 11, wherein the establishing of the connection comprises forwarding information indicating the start of data transmission to the first and second clients.

14. The at least one computer readable medium of claim 11, wherein the allowing the server to relay data comprises closing sockets that receive data requesting an access from the first and second clients when relay of the data received from the first and second clients terminates.

15. The at least one computer readable medium of claim 11, wherein the mapped connection information comprises connection information mapped using a value obtained as a result of a relation operation as a key value, wherein the relation operation is performed using the IP address and port number of either the first or second client.

16. The system of claim 1, wherein:
the connection information storage module is a connection information table including address mapping information including records having a relation R field, first client information field, and second client information field;
the connection information includes the first and second client information, which includes addresses, port numbers, and sockets of the server for transmitting and receiving data;
the server socket module performs a relation operation to obtain a relation R when the server socket module receives first client information;
the server socket module checks whether the relation R exists in one of the relation R fields of records in the connection information table;
the server socket module adds first client information to first client field of the one record when the relation R exists in the connection information table;
the server socket module adds the first client information to the first client field, the relation R to the relation R field, and a NULL set to the second client information field when the relation R does not exist in the connection information table; and the server socket module replaces the NULL set of the second client information field when the server socket module receives the second client information from the second client.

17. The method of claim 6, wherein establishing a connection with the first and the second clients at the application layer further comprises:
performing a relation operation to provide a relation R upon receipt of the access request by the first client; and
mapping connection information into a connection information table by checking whether the relation R exists in one of relation R fields of records in the connection information table, wherein each record includes relation R field, first client information field, and second client information field.

18. The method of claim 17, wherein establishing a connection with the first and the second clients at the application layer further comprises:
adding first client information to first client field of record including the relation R;
adding first client information to first client field of another record when the relation R does not exist in the connection information table, adding the relation R to the another record, and adding a NULL set to the second client information field of the another record.

19. The at least one computer readable medium of claim 11, wherein establishing a connection with the first and the second clients at the application layer further comprises:
performing a relation operation to provide a relation R upon receipt of the access request by the first client; and
mapping connection information into a connection information table by checking whether the relation R exists in one of relation R fields of records in the connection information table, wherein each record includes relation R field, first client information field, and second client information field.

20. The at least one computer readable medium of claim 11, wherein establishing a connection with the first and the second clients at the application layer further comprises:
adding first client information to first client field of record including the relation R;
adding first client information to first client field of another record when the relation R does not exist in the connection information table, adding the relation R to the another record, and adding a NULL set to the second client information field of the another record.

21. A method for relaying data using a socket application program, the method comprising:
establishing a connection between a first client and a second client through a server; and
allowing the server to relay data received from the first and the second clients at a network layer using mapped connection information.

22. At least one computer readable medium storing instructions that control at least one processor to perform a method for relaying data using a socket application program comprising:
establishing a connection between a first client and a second client through a server; and
allowing the server to relay data received from the first and the second clients at a network layer using mapped connection information.
